(19) United States
(12) Patent Application Publication
(10) Pub. No.: US 2009/0259502 A1
(43) Pub. Date: Oct. 15, 2009

(54) Quality-Based Media Management for Network-Based Media Distribution

(76) Inventors: Daniel David Erlewine, Cupertino, CA (US); Eric John Gray, Sunnyvale, CA (US); Max Muller, San Jose, CA (US); Jonathan B. Leffert, Mountain View, CA (US); Ricardo Cortes, Los Gatos, CA (US); Kate Wormington, San Carlos, CA (US)

Correspondence Address: TECHNOLOGY & INNOVATION LAW GROUP, PC, ATTN: 101, 19200 STEVENS CREEK BLVD., SUITE 240, CUPERTINO, CA, 95014, US

(21) Appl. No.: 12/101,014

(22) Filed: Apr. 10, 2008

(51) Int. Cl. G06Q 10/00; G06F 17/30

(52) U.S. Cl. 705/7; 705/28; 705/30

(57) ABSTRACT

Disclosed are techniques and configurations for monitoring quality of digital media assets available from a network-based media distribution system, and taking action to make those digital media assets that have quality deficiencies unavailable from the network-based media distribution system. The network-based media distribution system can provide an online media store from which users can acquire those of the digital media assets that are deemed available. In one embodiment, digital media assets that have quality deficiencies can be rapidly discovered and automatically removed from being available at an online media store.

### BACKGROUND OF THE INVENTION

1. Field of the Invention

The present invention relates to media management and, more particularly, to media management in view of quality deficiencies.

2. Description of the Related Art

Today, online media stores, such as iTunes™ Media Store, allows customers (i.e., online users) to purchase or rent media items, such as music or videos, over the Internet. Often, at online media stores, numerous media items made available and are provided by various different content providers, such as music labels or movie companies. Software tools, such as iProducer™ and Label Connect™ available from Apple Inc. of Cupertino Calif., can assist content providers with online submission of media content to the iTunes™ Media Store. Although submitted media content can be checked for quality considerations, media content made available at an online media store can still have poor quality. The poor quality can be inherent in the media content as originally submitted or can result from corruption that occurs while the media content is being maintained at the online media store.

Online media stores want to prevent purchase (e.g., sale or rental) of media items which have poor quality. Hence, when user complains of having purchased poor quality media items, customer service representatives may be required to process refunds. Online store representatives can periodically review refund activity and manually examine problematic media items to determine whether the media item is of poor quality and needs to be replaced. Unfortunately, however, such manual and periodic approach is slow and can lead to numerous sales of the problematic media item before any action is taken.

Therefore, there is a need for improved approaches to reduce purchase (e.g., sales or rentals) of poor quality media items.

### SUMMARY OF THE INVENTION

The invention relates to techniques and configurations for monitoring quality of digital media assets available from a network-based media distribution system, and taking action to make those digital media assets that have quality deficiencies unavailable from the network-based media distribution system. The network-based media distribution system can provide an online media store from which users can acquire those of the digital media assets that are deemed available. In one embodiment, digital media assets that have quality deficiencies can be rapidly discovered and automatically removed from being available at an online media store.

The invention can be implemented in numerous ways, including as a method, system, device, apparatus (including computer readable medium). Several embodiments of the invention are discussed below.

As a computer-implemented method for managing media content availability at an online media repository, one embodiment of the invention can, for example, include at least: tracking quality issues for a plurality of media items available for acquisition from the online media repository; determining whether a particular media item has a likely quality problem based on the quality issues being tracked for the particular item; and automatically removing the particular media item from being available from the online media repository if it is determined that the particular media item has a likely quality problem.

As a computer-implemented method for managing media content availability at an online media repository, one embodiment of the invention can, for example, include at least: obtaining a number of quality-based refunds associated with a particular media item that is available for acquisition from the online media repository; obtaining a quality threshold associated with the particular media item; determining whether the number of quality-based refunds associated with the particular media item is greater than the quality threshold associated with the particular media item; and removing the particular media item from the online media repository if it is determined that the number of quality-based refunds is greater than the quality threshold.

As a computer readable storage medium including at least executable computer program code for managing media content availability at an online media repository, one embodiment of the invention can, for example, include at least: computer program code for determining whether at least one digital media asset has a quality concern, the at least one digital media asset being at least one of a plurality of digital media assets available for acquisition from the online media repository; and computer program code for automatically removing the at least one digital media asset from being available from the online media repository if it is determined that the particular digital media asset has a quality concern.

As a media management system for an online media store, one embodiment of the invention can, for example, include at least: a media database interface configured to interact with a media database that stores media content for a plurality of digital media assets available for distribution from the online media store; a media store interface configured to interact with the online media store; a media management module configured to manage the digital media assets available for distribution from the online media store; a quality monitoring module configured to monitor quality of the plurality of digital media assets; a media unavailability module configured to facilitate rending of one or more of the digital media assets stored in the media database unavailable for distribution from the online media store based on the quality of the respective digital media assets being monitored; and a media submission module configured to facilitate submission of media content for the digital media assets to the media database and to facilitate resubmission of media content for the one or more of the digital media assets that are unavailable for distribution.

Other aspects and embodiments of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a block diagram of a media distribution system according to one embodiment of the invention.

FIG. 2 is a block diagram of a media management system according to one embodiment of the invention.

FIG. 3 is a flow diagram of a media availability process according to one embodiment of the invention.

FIGS. 4A and 4B are flow diagrams of a media availability process according to one embodiment of the invention.

FIG. 5 is a flow diagram of a media resubmission process according to one embodiment of the invention.

FIG. 6 is a flow diagram of a redelivery process according to one embodiment of the invention.

### DETAILED DESCRIPTION OF THE INVENTION

The invention relates to techniques and configurations for monitoring quality of digital media assets available from a network-based media distribution system, and taking action to make those digital media assets that have quality deficiencies unavailable from the network-based media distribution system. The network-based media distribution system can provide an online media store from which users can acquire those of the digital media assets that are deemed available. In one embodiment, digital media assets that have quality deficiencies can be rapidly discovered and automatically removed from being available at an online media store. Advantageously, when a digital media asset having a quality deficiency is detected, the digital media asset can be removed from being available from the online media store such that delivery of the problematic digital media asset can minimized.

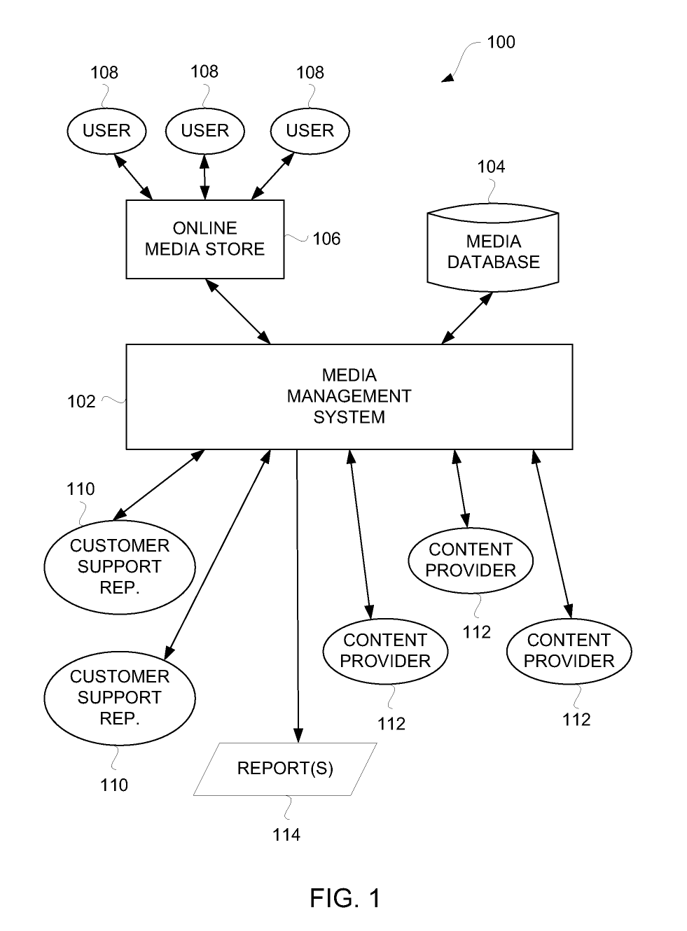

Embodiments of various aspects of the invention are discussed below with reference to FIGS. 1-6. However, those skilled in the art will readily appreciate that the detailed description given herein with respect to these figures is for explanatory purposes as the invention extends beyond these limited embodiments.

FIG. 1 is a block diagram of a media distribution system 100 according to one embodiment of the invention. The media distribution system 100 includes a media management system 102 that manages various media items for distribution, namely, electronic distribution. Among other things, the media management system 102 controls availability of the various media items for distribution. The media distribution system 100 includes a media database 104 and an online media store 106. The media database 104 stores the various media items. In other words, media content for the various media items is stored in the media database 104. The media database 104 can also store management information to assist in the media management system 102 in managing the distribution of the media items.

One or more users 108 can interact with the online media store 106 by way of a data network, such as the Internet. In doing so, the users 108 can report to the online media store 106 that they believe that a particular media item has a quality defect. For example, assume that the user 108 previously purchased a particular media item from the online media store 106. Subsequently, the same user 108 can discover that the particular media item that they received is defective in some way. The user 108 can report the defect to the online media store 106. The online media store 106 can then provide the defect to the media management system 102.

Additionally, the media distribution system 100 can support one or more customer support representatives 110. The users 108 of the online media store 106 might contact the customer support representative 110 by telephone, e-mail or instant message. In any case, the customer support representative 110 can be informed of quality concerns regarding particular media items. In one implementation, the media management system 102 monitors a number of refunds that the customer support representatives 110 have received from the users 108 with respect to specific media items. In another implementation, the management system 102 monitors a number of refunds to the users 108 that have self-reported quality concerns with respect to specific media items.

The media management system 102 can evaluate whether the volume or frequency of quality concerns indicates that a particular media item has a quality deficiency. For example, the media management system 102 can compare the number of refunds for a given media item against a threshold level to determine whether the particular media item is deemed to be of insufficient (e.g., poor) quality. In any case, when a particular media item is deemed to have a quality deficiency, the media management system 102 can operate to remove the media item from being available to the online media store 106. In other words, once a particular media item is removed from the online media store 106, the users 108 can no longer purchase the particular media item. To remove a particular media item from being available on the online media store 106, the media management system 102 can store an indication that the particular media item is currently unavailable. Such an indication can, for example, be stored in the media database 104. It should be understood that the removal of a particular media item need not physically expunge the media item from the media distribution system 100 but can instead operate to “hide” the media item from being displayed at the online media store.

In addition, after the media management system 102 has removed any particular media item from being available at the online media store 106, the media management system 102 can also cause an appropriate content provider 112 to be notified of the quality issue with respect to the particular media item. For example, the media management system 102 can cause an electronic notification to be transmitted to the content provider 112 regarding the particular media item. The electronic notification can be automatically transmitted so that the content provider 112 can be promptly alerted as soon as the particular media item is removed from being available for purchase. In response to the notification, the content provider 112 can investigate the quality deficiency and submit a replacement media item whose content does not have the same quality deficiency. After the media management system 102 receives the replacement media item, the media management system 102 can store the replacement media item in the media database 104 and operate to again permit the particular media item to be available for purchase at the online media store 106.

The media management application 100 can also generate one or more reports 114 for interested persons. The reports 114 can inform the interested persons about various media management conditions. For example, the reports 114 can inform interested persons as to (i) which and when media items have been removed (hidden) due to quality concerns, (ii) which and how many purchased media items have been refunded due to quality issues, (iii) whether manual override is set, etc.

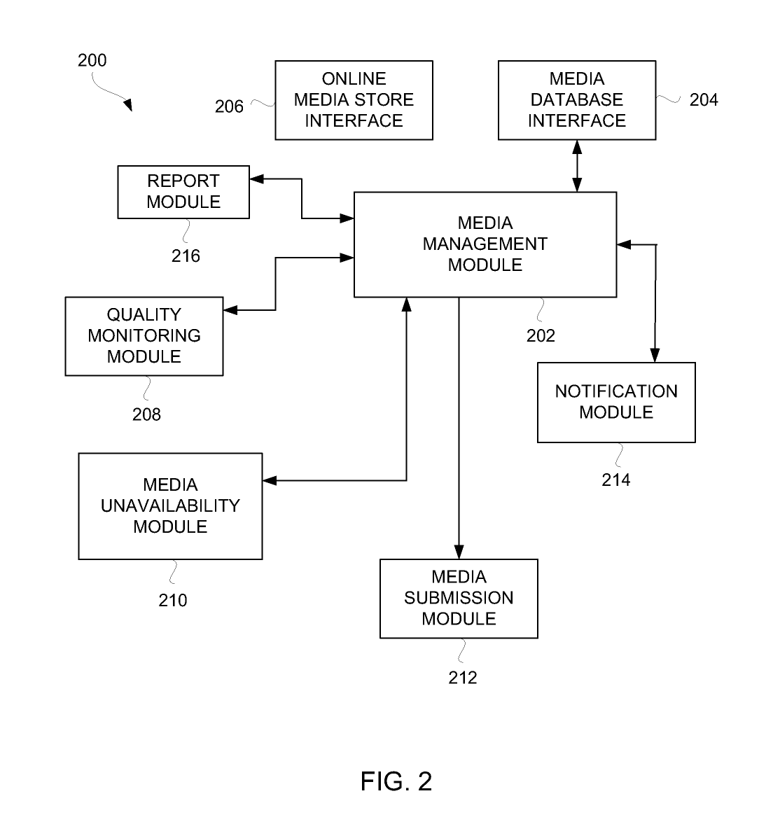

FIG. 2 is a block diagram of a media management system 200 according to one embodiment of the invention. The media management system 200 is, for example, suitable for use as the media management system 102 illustrated in FIG. 1.

The media management system 200 includes a media management module 202 that controls the overall operation of the media management system 200. The media management module 202 can interact with a media database (e.g., media database 104) via a media database interface 204. The media management module 202 can interact with an online media store (e.g., online media store 106) via an online media store interface 206.

The media management system 200 can further include a quality monitoring module 208. The quality monitoring module 208 can monitor (e.g., track) refunds that have been issued with respect to the various media items being managed by the media management system 200. In one embodiment, the quality monitoring module 208 can monitor (e.g., track) refunds with respect to individual media items. The quality monitoring module 208 can also monitor refunds with respect to groups of media items, such as playlist (e.g., albums). In one implementation, the quality monitoring module 208 is a refund module.

The media management system 200 can also include a media unavailability module 210. When the media management system 200 determines that a particular media item should be made unavailable, namely, removed from distribution, the media unavailability module 210 can be invoked to cause the particular media item to be removed. In other words, the particular media item becomes unavailable from further distribution via the online media store. In one implementation, the media unavailability module 210 is a media removal module.

The media management system 200 can also include a media submission module 212 and a notification module 214. A content provider can interact with the media submission module 212 to submit one or more media items to the media management system 200. The media submissions can pertain to initial content submissions for new media files or can be submissions of replacement content for previously removed media items. If a particular media item becomes unavailable (by the media unavailability module 210), the notification module 214 can cause a notification to be sent (e.g., electrically transmitted) to the content provider that submitted the now unavailable media item to the media management system 200. The notification can not only alert the content provider that one of their media items has become unavailable but also provide information to assist the content provider in understanding the quality deficiency of the media item.

Still further, the media management system 200 can include a report module 216. The media management module 202 can utilize the report module 216 to produce one or more reports that can be supplied to interested persons. For example, the one or more reports can be automatically generated utilizing data maintained by the media management module 202 so as to inform interested persons of the management status of the various media items. The one or more reports that are produced by the report module 210 can be electronically transmitted to the one or more interested persons. At least one of the reports can provide data on those media items that have become unavailable.

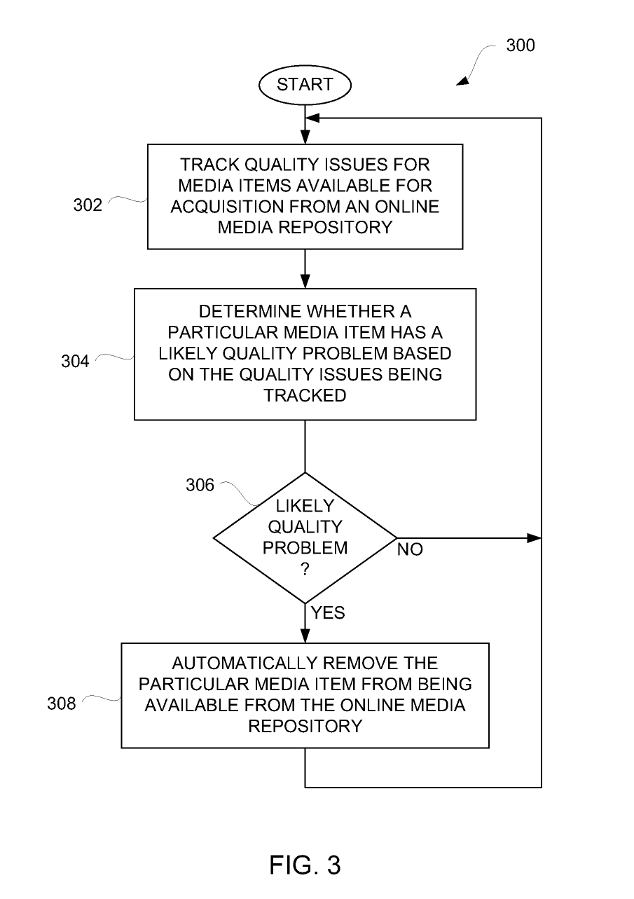

FIG. 3 is a flow diagram of a media availability process 300 according to one embodiment of the invention. The media availability process 300 can, for example, be performed by the media distribution system 100 illustrated in FIG. 1. The media availability process 300 can, in another example, be performed by the media management system 200 illustrated in FIG. 2, namely, the media management module 202 together with the quality monitoring module 208 and the media unavailability module 210.

The media availability process 300 can operate to track 302 quality issues for media items that are available for acquisition from an online media repository. For example, the online media repository, such as an online media store, can make media items available for distribution (e.g., purchase, rent or otherwise). Next, the media availability process 300 can determine 304 whether any particular media item has a likely quality problem based on the quality issues being tracked. A decision 306 can then determine whether the particular media item has a likely quality problem.

When the decision 306 determines that the particular media item does have a likely quality problem, the particular media item can be automatically removed 308 from being available from the online media repository. Here, a particular media item that is determined to have a likely quality problem can be automatically removed from being available from the online media repository. For example, when a particular media item is available for distribution (e.g., purchase, rental or otherwise) from an online media store (e.g., online media store 106) and it is determined that the particular media item has a likely quality problem, the particular media item can be quickly made unavailable at the online media store. Consequently, a particular media item having a likely quality problem can be rapidly identified and rapidly removed from being further distributed by an online media store, thereby limiting the distribution of defective media content.

On the other hand, when the decision 306 determines that the particular media item does not have a likely quality problem, the block 308 can be bypassed. Following the block 308, or its being bypassed, the media availability process 300 can return to repeat the block 302 and subsequent blocks so that quality issues with other media items can be similarly processed.

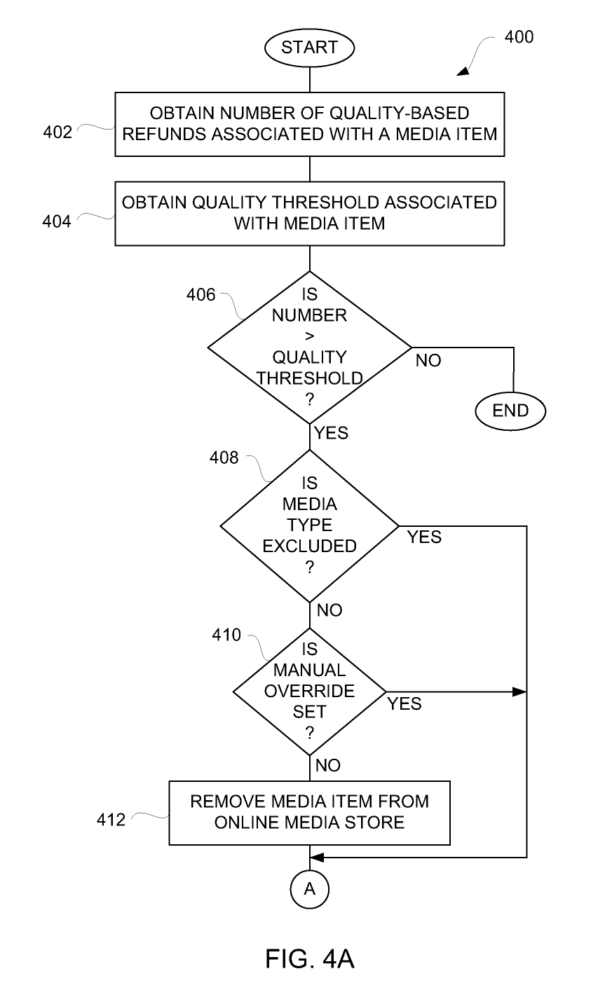

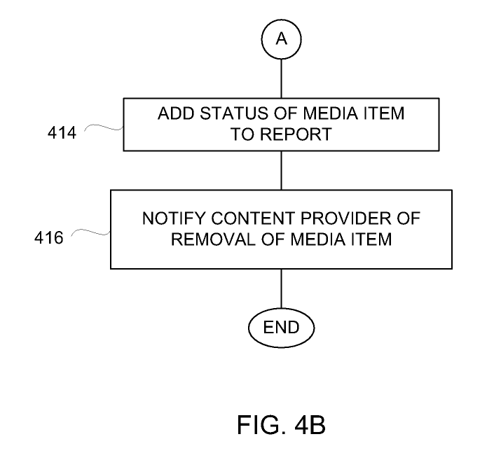

FIGS. 4A and 4B are flow diagrams of a media availability process 400 according to one embodiment of the invention. The media availability process 400 can, for example, be performed by the media distribution system 100 illustrated in FIG. 1. The media availability process 400 can, in another example, be performed by the media management system 200 illustrated in FIG. 2, namely, the media management module 202 together with the quality monitoring module 208 and the media unavailability module 210.

The media availability process 400 obtains 402 a number of quality-based refunds associated with a media item. For example, a media management system can track or monitor the number of quality-based refunds for each of a plurality of media items supported by the media management application. A quality threshold associated with the media item can also be obtained 404. The media management system can utilize one or more quality thresholds. The quality thresholds can, for example, be provided for each of a plurality of different types of media items (e.g., different content types). For example, one quality threshold can be utilized for audio items (such as music), and another (different) quality threshold can be utilized for video items (such as movies). In one implementation, five (5) quality problem reports (or quality-based refunds) can be the quality threshold for music, and two (2) quality problem reports (or quality-based refunds) can be the quality threshold for movies. Also, different content providers could receive different thresholds. Quality thresholds can also be provided with respect to groups of media items, such as playlist (e.g., album).

Next, a decision 406 determines whether the number of quality-based refunds exceeds the quality threshold associated with the media item. When the decision 406 determines that the number of quality-based refunds does not exceed the quality threshold associated with the media item, the media availability process 400 can end. In this case, the decision 406 is effectively concluding that the media item being considered does not, as yet, have a likely quality problem. As a result, the media item remains available for acquisition or distribution.

On the other hand, when the decision 406 determines that the number of quality-based refunds for the media item does exceed the quality threshold associated with the media item (or its associated group of media items), a decision 408 can determine whether the media type associated with the media item is excluded from subsequent media availability processing. For example, certain types of media items, such as videos, can be excluded from media availability processing since quality evaluations (e.g., by end users) tend to be more subjective and less reliable. When the decision 408 determines that the media type associated with the media item is not excluded from further processing, a decision 410 can determine whether a manual override has been set with respect to the media item. A manual override can be set with respect to a particular media item to clause any quality-based removal of such media item to be avoided. When the decision 410 determines that a manual override has not been set for the media item, the media item can be removed 412 from the online media store. Once the media item has been removed 412 from the online media store, the media item is no longer available for distribution via the online media store. In the event that the media type is excluded from removal processing or in the event that the manual override has been set for the media item, the block 412 is bypassed so that the media item is not removed from the online media store.

Following the block 412, or its being bypassed, the media availability process 400 can add 414 a status of the media item to a report. For example, the report can be a daily or weekly report on quality issues at the online media repository. Further, a content provider can be notified 416 of the removal of the media item. As an example, the content provider associated with the media item can automatically send an electronic message (e.g., email, audio message, instant message) to inform the content provider that the media item has been removed. Following the block 416, the media availability process 400 can end.

If the media item is part of a group of media items (e.g., playlist), the complete group of media items can be removed (e.g., based on a group quality threshold) when one or more of one of its individual media items becomes unavailable. Alternatively, the group of media items can remain with the remaining available media items of the group being acquired individually. Also, in another embodiment, if the user requests to buy the group of media items (e.g., an album) while one or more of the media items are unavailable, the user can be notified that the content is in the process of being updated and that they should try later. In such case, in one implementation, the user can also be provided with an estimated time for when to try again. In another implementation, the user could be notified (e.g., email, on log-in, etc.) that the playlist content has been updated and is now available for purchase.

In one embodiment, the media availability process 400 is computer implemented so that the monitoring of quality deficiencies for media items can be performed in an automated manner. When certain media items are determined to have quality deficiencies, such media items can be automatically removed from being available and appropriate content providers can be automatically notified. In one embodiment, the media availability process 400 can be periodically invoked to monitor for quality deficiencies of media items. For example, the media availability process 400 might be invoked daily, hourly, etc. Hence, although the media availability process 400 is described with reference to a media item, the media availability process can be repeated for each of a plurality of different media items. Accordingly, the media availability process 400 can be periodically performed to subsequently evaluate one or more media items for quality problems.

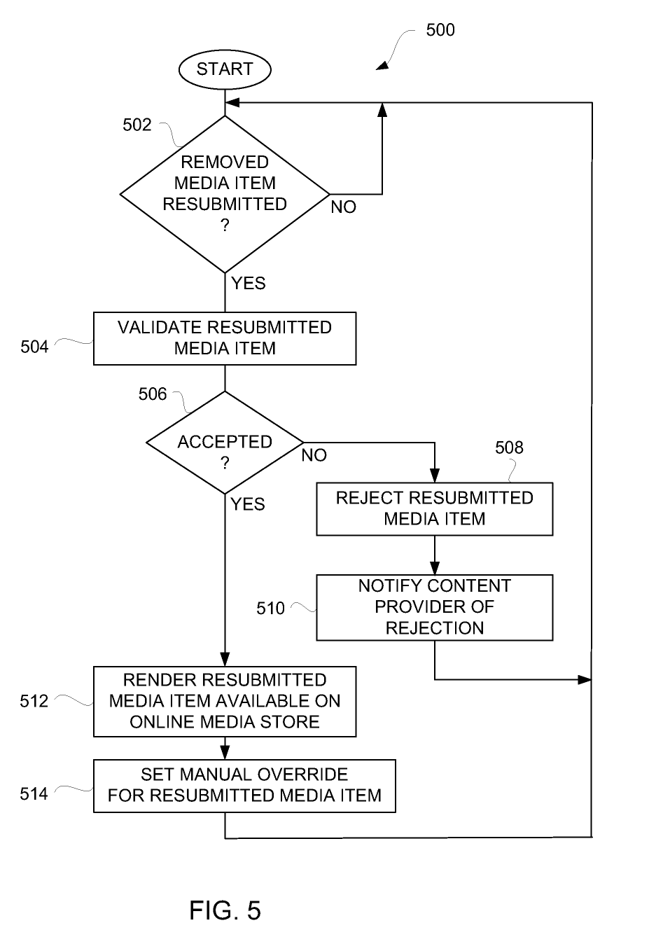

FIG. 5 is a flow diagram of a media resubmission process 500 according to one embodiment of the invention. The media resubmission process 500 can be performed to resubmit a media item that had been previously removed due to quality concerns. For example, in a media item could have been removed from availability at an online media store by the media availability process 300 illustrated in FIG. 3 or the media availability process 400 illustrated in FIGS. 4A and 4B.

The media resubmission process 400 can begin with a decision 502. The decision 502 can determine whether any previously removed media item has been resubmitted. When the decision 502 determines that any previously removed media item has not been resubmitted, the media are resubmission process 500 can await such a resubmission. In other words, the media resubmission process 400 can be invoked or performed when a previously removed media item has been submitted.

Once the decision 502 determines that a previously removed media item has been resubmitted, the resubmitted media item can be validated 504. The validation 504 of the resubmitted media item can be performed by quality reviewers (quality control persons) and/or computerized processing. The validation attempts to evaluate whether the resubmitted media item satisfies certain criteria, including quality standards. Next, a decision 506 can determine whether the resubmitted media item has been accepted in view of the validation 504.

When the decision 506 determines that the resubmitted media item was not successfully validated, the resubmitted media item is not accepted. When the resubmitted media item is not accepted, the resubmitted media item is rejected 508. In addition, the content provider submitted the resubmitted media item can also be notified 510 that the resubmitted media item has been rejected. Following the notification 510, the media resubmission process 500 can return to repeat the decision 502 and subsequent blocks so that other resubmissions can be similarly processed.

Alternatively, when the decision 506 determines that the resubmitted media item was properly validated 504, the media item is accepted. When the resubmitted media item is accepted, the resubmitted media item is rendered 512 available on the online media store. In such case, the previously removed media item that had quality-based deficiencies have been replaced by a resubmitted version of the media item which satisfies quality standards.

Further, subsequent removal of the resubmitted media item can be disabled 514. In one implementation, a manual override can be set for the resubmitted media item to disable 514 its removal. The manual override can operate to prevent subsequent removal of the resubmitted media item. For example, given that the prior version of the media item with quality-based deficiencies is still being utilized by many users, refunds or other quality issues that are being reported are likely associated with the prior version of the media item that was removed as opposed to the resubmitted version of the media item. Hence, disablement 514 of subsequent removal, e.g., the manual override, prevents removal of the resubmitted media item. In one embodiment, disablement 514 is utilized for only a period of time after which the disablement 514 expires and the resubmitted media item can be removed if quality-based issues develop. In an alternative embodiment, instead or in addition to the disablement 514, refunds or quality issues that are from users that have the prior media item (as opposed to the resubmitted media item) are no longer counted because they pertain to an already corrected quality issue, thereby avoiding subsequent removal of the resubmitted media item due to defects still being reported by users having the prior version. Following the disablement 514 of subsequent removal, the media resubmission process 500 can return to repeat the decision 502 and subsequent blocks so that other resubmission can be similarly processed.

According to another aspect, prior acquirers (e.g., purchasers) of a media item with deficient quality can be accommodated. The prior purchasers can receive a notification, a refund, and/or a redelivery of the media item. In one embodiment, a redelivery process can determine those prior purchases that are eligible to receive a resubmitted version of the media item. Once the eligible purchases are determined, purchasers for such eligible purchases can be identified. Thereafter, the resubmitted version of the media item can be delivered to the identified purchasers.

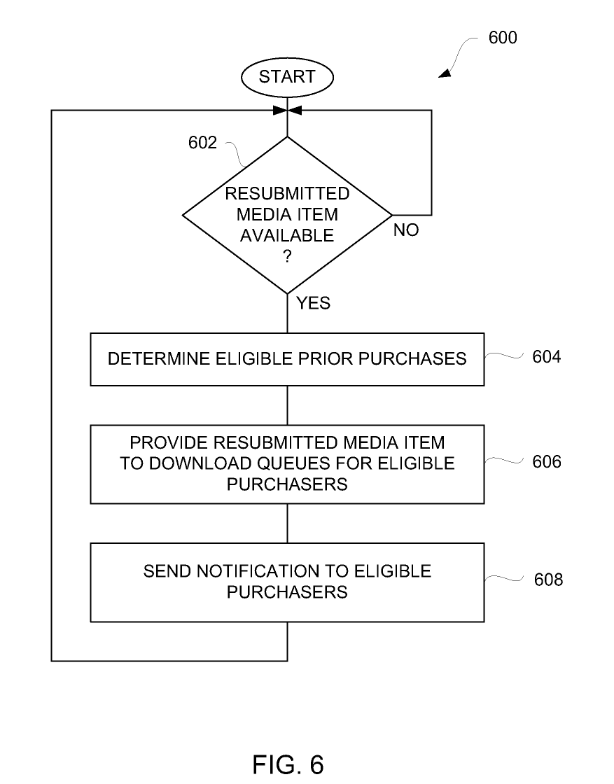

FIG. 6 is a flow diagram of a redelivery process 600 according to one embodiment of the invention. The redelivery process 600 can, for example, be performed by the media distribution system 100 illustrated in FIG. 1. The redelivery process 600 can, in another example, be performed by the media management system 200 illustrated in FIG. 2, namely, the media management module 202 together with the media database interface 204, the online media store interface 206 and the notification module 214.

The redelivery process 600 can begin with a decision 602 that determines whether a resubmitted media item is available. Here, after a media item has been rendered unavailable, a replacement media item can be resubmitted so that the media item is effectively made available again. When the decision 602 determines that a resubmitted media item is not available, the redelivery process 600 awaits availability of a resubmitted the item. On the other hand, when the decision 602 determines that a resubmitted media item is now available, the redelivery process 600 can continue. In other words, the redelivery process 600 can be deemed invoked when a resubmitted media item is available.

Once the decision 602 determines that a resubmitted media item is available, eligible purchases are determined 604. Here, prior purchases of the original version of the media item (that is now unavailable) are examined to determine 604 those that are eligible for a redelivery of the resubmitted version of the media item. For example, a database (e.g., the media database 104) can store purchase date (and time) for the media items and also a resubmission date (and time) for resubmitted version of the media item. In one embodiment, those prior purchases of the prior version of the media item that were made prior to the date (and time) of resubmission can be deemed eligible. Next, the resubmitted media item can be provided 606 to download queues for the eligible purchasers. In addition, a notification can be sent 608 to each of the eligible purchasers. Following the block 608, the redelivery process 600 can return to repeat the decision 602 and subsequent blocks so that similar processing can be performed for other resubmitted media items that become available. The download queues can include an identification of one or more media items that are waiting to be delivered (e.g., downloaded) to a user (purchaser). When a purchase connects to the online media store, the online media store can check with the media management system to determine whether the corresponding download queue has any media items that are to be delivered. If so, the purchaser can start downloading such one or more media items or can opt to defer the downloading until some other time.

The various aspects, embodiments, implementations or features of the invention can be used separately or in any combination.

Media assets, namely, digital media assets, can pertain to audio (e.g., songs, audio books, podcasts), videos (e.g., movies, music videos) or images (e.g., photos), as different types of media assets. Media assets also include any combinations of these different types of media assets with other data.

The invention is preferably implemented by software, hardware, or a combination of hardware and software. The invention can also be embodied as computer readable code on a computer readable medium (or computer readable storage medium). The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

The advantages of the invention are numerous. Different embodiments or implementations may, but need not, yield one or more of the following advantages. One advantage of certain embodiments of the invention is that digital media assets identified as having likely quality concerns can be quickly and automatically removed from an online media store so that sales or rentals of problematic media content can be halted. Such automatic and prompt action can enhance user experience with online media stores and can reduce the number of refunds being processed by customer service representatives. Another advantage of certain embodiments of the invention is that users that have already acquired a digital media asset that is quality deficient can be alerted that a replacement will be forthcoming and/or that a replacement is now available. Still another advantage of certain embodiments of the invention is that content providers can be quickly notified of quality concerns so that they may be more rapidly addressed.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computer-implemented method for managing media content availability at an online media repository, said method comprising:
tracking quality issues for a plurality of media items available for acquisition from the online media repository;
determining whether a particular media item has a likely quality problem based on the quality issues being tracked for the particular media item; and
automatically removing the particular media item from being available from the online media repository if said determining determines that the particular media item has a likely quality problem.

2. A computer-implemented method as recited in claim 1, wherein said method further comprises:
determining a content provider associated with the particular media item; and
electronically notifying the content provider that the particular media item has a likely quality problem.

3. A computer-implemented method as recited in claim 2, wherein said method further comprises:
subsequently receiving a resubmitted version of the particular media item; and
rendering the resubmitted version of the particular media item available at the online media repository.

4. A computer-implemented method as recited in claim 3, wherein said method further comprises:
avoiding subsequent removal of the resubmitted version of the particular media item from the online media repository due to quality issues associated with the removed version of the particular media item.

5. A computer-implemented method as recited in claim 1, wherein said method further comprises:
subsequently receiving a resubmitted version of the particular media item;
validating the resubmitted version of the particular media item; and
rendering the resubmitted version of the particular media item available at the online media repository if the resubmitted version of the particular media item has been successfully validated.

6. A computer-implemented method as recited in claim 1, wherein said tracking of the quality issues for the plurality of media items available for acquisition from the online media repository comprises tracking refund activity for the plurality of media items.

7. A computer-implemented method as recited in claim 1, wherein said method further comprises:
determining prior recipients of the particular media item determined to have a likely quality problem; and
facilitating electronic delivery of the resubmitted version of the particular media item to the prior recipients.

8. A computer-implemented method as recited in claim 1, wherein said method further comprises:
determining prior recipients of the particular media item determined to have a likely quality problem; and
electronically notifying the prior recipients of availability of the resubmitted version of the particular media item.

9. A computer-implemented method as recited in claim 1, wherein the online media repository is an online media store.

10. A computer-implemented method for managing media content availability at an online media repository, said method comprising:
obtaining a number of quality-based refunds associated with a particular media item that is available for acquisition from the online media repository;
obtaining a quality threshold associated with the particular media item;
determining whether the number of quality-based refunds associated with the particular media item is greater than the quality threshold associated with the particular media item; and
removing the particular media item from the online media repository if said determining determines that the number of quality-based refunds is greater than the quality threshold.

11. A computer-implemented method as recited in claim 10, wherein said method further comprises:
determining a content provider associated with the particular media item; and
electronically notifying the content provider that the particular media item has been removed from the online media repository.

12. A computer-implemented method as recited in claim 11, wherein said method further comprises:
subsequently receiving a resubmitted version of the particular media item;
validating the resubmitted version of the particular media item; and
rendering the resubmitted version of the particular media item available at the online media repository if the resubmitted version of the particular media item has been successfully validated.

13. A computer-implemented method as recited in claim 12, wherein said method further comprises:
electronically notifying the content provider that the resubmitted version of the particular media item has been rejected if the resubmitted version of the particular media item has not been successfully validated.

14. A computer-implemented method as recited in claim 12, wherein said method further comprises:
avoiding subsequent removal of the resubmitted version of the particular media item from the online media repository due to quality-based refunds associated with the removed version of the particular media item.

15. A computer-implemented method as recited in claim 12, wherein said method further comprises:
determining prior recipients of the particular media item that has been removed from the online media repository; and
electronically notifying the prior recipients of availability of the resubmitted version of the particular media item.

16. A computer-implemented method as recited in claim 10, wherein said method further comprises:
determining a media type for the particular media item; and
determining whether removal of the particular media item by said removing is prevented based on the media type.

17. A computer-implemented method as recited in claim 10, wherein said obtaining comprises:
determining a media type for the particular media item; and
obtaining of the quality threshold associated with the particular media item based on the media type.

18. A computer-implemented method as recited in claim 10, wherein the online media repository is an online media store.

19. A computer readable storage medium including at least executable computer program code for managing media content availability at an online media repository, said computer readable storage medium comprising:
computer program code for determining whether at least one digital media asset has a quality concern, the at least one digital media asset being at least one of a plurality of digital media assets available for acquisition from the online media repository; and
computer program code for automatically removing the at least one digital media asset from being available from the online media repository if it is determined that the particular digital media asset has a quality concern.

20. A computer readable storage medium as recited in claim 19, wherein said computer readable storage medium further comprises:
computer program code for determining a content provider associated with the at least one digital media asset; and
computer program code for electronically notifying the content provider that the at least one digital media asset has a quality concern.

21. A computer readable storage medium as recited in claim 20, wherein said computer readable storage medium further comprises:
computer program code for subsequently receiving a resubmitted version of the at least one digital media asset; and
computer program code for rendering the resubmitted version of the at least one digital media asset available at the online media repository.

22. A computer readable storage medium as recited in claim 21, wherein said computer readable storage medium further comprises:
computer program code for determining prior recipients of the at least one digital media asset determined to have a quality concern; and
computer program code for facilitating electronic delivery of the resubmitted version of the at least one digital media asset to the prior recipients.

23. A media management system for an online media store, said media management system comprises:
a media database interface configured to interact with a media database that stores media content for a plurality of digital media assets available for distribution from the online media store;
a media store interface configured to interact with the online media store;
a media management module operatively connected to said media database and said media store database, said media management module being configured to manage the digital media assets available for distribution from the online media store;
a quality monitoring module operatively connected to said media management module, said quality monitoring module being configured to monitor quality of the plurality of digital media assets;
a media unavailability module operatively connected to said media management module, said media unavailability module being configured to facilitate rending of one or more of the digital media assets stored in the media database unavailable for distribution from the online media store based on the quality of the respective digital media assets being monitored; and
a media submission module operatively connected to said media management module, said media submission module being configured to facilitate submission of media content for the digital media assets to the media database and to facilitate resubmission of media content for the one or more of the digital media assets that are unavailable for distribution.
